(19) United States
(12) Patent Application Publication
(10) Pub. No.: US 2020/0266506 A1
(43) Pub. Date: Aug. 20, 2020

(54) BATTERY MODULE AND SYSTEM

(71) Applicant: 3M INNOVATIVE PROPERTIES COMPANY, St. Paul, MN (US)

(72) Inventors: Harald Stuetz, Semriach (AT); Bernhard Brunnsteiner, Graz (AT); Veronika Obersteiner, Graz (AT)

(21) Appl. No.: 16/792,919

(22) Filed: Feb. 18, 2020

Related U.S. Application Data
(60) Provisional application No. 62/806,944, filed on Feb. 18, 2019.

(51) Int. Cl. H01M 10/6556; H01M 2/04; H01M 2/12; H01M 10/647; H01M 10/6552; H01M 10/48

(52) U.S. Cl. CPC H01M 10/6556; H01M 2/0404; H01M 2/043; H01M 10/486; H01M 10/647; H01M 10/6552; H01M 2/1241

(57) ABSTRACT

A battery module includes a housing. The battery module also includes a plurality of electrochemical cells disposed adjacent to each other and received within the housing. The battery module further includes an inner cover disposed between the housing and the plurality of electrochemical cells. The inner cover includes a top surface facing the housing and a bottom surface facing the plurality of electrochemical cells. The inner cover also includes a plurality of fluid channels defined on the bottom surface and extending along a length of the inner cover. Each of the plurality of channels is configured to receive a fluid. The inner cover further includes a plurality of grooves defined on the top surface and extending along the length of the inner cover. Each of the plurality of grooves is configured to receive one or more electrical components.

### TECHNICAL FIELD

The present disclosure relates generally to improvements in or relating to battery modules and is more particularly concerned with thermal management of battery modules and systems.

### BACKGROUND

A battery module includes of a number of electrochemical cells disposed within a housing along with a number of electrical/electronic components, such as wires, cables, sensors, and the like. The electrochemical cells may be large format cells, such as prismatic type cells or pouch type cells. During operation, the electrochemical cells generate considerable heat which needs to be dissipated effectively in order to allow safe functioning of the electrochemical cells and prevent failure of the battery module. Hence, a thermal management system may be employed within the battery module in order to control an operational temperature of the electrochemical cells within a safe threshold.

One example of the thermal management system is a direct contact type or an immersion type thermal management system. In such a system, the housing of the battery module may be flooded with a thermal management liquid such that the electrochemical cells may be submerged within the thermal management fluid for improved heat transfer. However, due to limited space and/or complex structural geometries within the housing, it may be difficult to provide effective circulation of the thermal management fluid within the housing around the electrochemical cells, in turn, reducing thermal management performance, increasing required volume of the thermal management fluid and causing uneven temperature distribution.

Additionally, in some situations, the electrical/electronic components may be disposed away from the thermal management fluid, thereby limiting heating or cooling of the electrical/electronic components. Also, during a thermal runaway event, as a rupture disc or valve of one or more electrochemical cells may open to release gas generated within the electrochemical cells, the gas may mix with the thermal management fluid resulting in contamination of the thermal management fluid. In some situations, the thermal management fluid may enter the ruptured electrochemical cell through the ruptured disc or valve, in turn, posing a safety hazard. Hence, there is a need for an improved battery module and system.

### SUMMARY

In one aspect, a battery module is provided. The battery module includes a housing. The battery module also includes a plurality of electrochemical cells disposed adjacent to each other and received within the housing. The battery module further includes an inner cover disposed between the housing and the plurality of electrochemical cells. The inner cover includes a top surface facing the housing and a bottom surface facing the plurality of electrochemical cells. The inner cover also includes a plurality of fluid channels defined on the bottom surface and extending along a length of the inner cover. Each of the plurality of channels is configured to receive a fluid. The inner cover further includes a plurality of grooves defined on the top surface and extending along the length of the inner cover. Each of the plurality of grooves is configured to receive one or more electrical components.

Each of the plurality of channels and/or each of the plurality of grooves may guide the fluid within the housing, in turn, improving circulation of the fluid within the battery module. The inner cover may also tightly secure the plurality of electrochemical cells within the housing. Also, each of the plurality of grooves may accommodate the one or more electrical components, such as sensors and/or cables, thus, providing direct contact cooling/heating of the electrical components. The plurality of channels may further enable direct contact cooling/heating of the plurality of electrochemical cells. Accordingly, a combination of the plurality of channels and the plurality of grooves may provide improved thermal management efficiency, improved temperature distribution, reduced fluid volume, and reduced pumping power.

In another aspect, a battery module is provided. The battery module includes a housing. The battery module also includes a plurality of electrochemical cells disposed adjacent to each other and received within the housing. The battery module further includes an inner cover disposed between the housing and the plurality of electrochemical cells. The inner cover includes a top surface facing the housing and a bottom surface facing the plurality of electrochemical cells. The inner cover includes a plurality of fluid channels defined on the bottom surface and extending along a length of the inner cover. Each of the plurality of channels is configured to receive a fluid. The inner cover also includes a plurality of openings spaced apart from each other along the length of the inner cover. The inner cover further includes one or more blocking features to prevent flow of fluid from the plurality of channels to the plurality of openings.

The plurality of channels may enable direct contact cooling/heating of the plurality of electrochemical cells via the fluid. Also, positions of the plurality of openings in a length direction corresponds to positions of the plurality of electrochemical cells, so that each of the plurality of openings is arranged above a corresponding electrochemical cell. Accordingly, each of the plurality of openings provides venting of gas from the corresponding electrochemical cell upon rupture of the corresponding electrochemical cell due to overpressure. Further, the one or more blocking features separate the fluid from each of the plurality of openings. Accordingly, the one or more blocking features prevents mixing of the fluid with the vent gas, in turn, limiting contamination of the fluid by the gas and entry of the fluid into a ruptured electrochemical cell.

In yet another aspect, a battery system is provided. The battery system includes a plurality of battery modules electrically connected to each other. Each of the plurality of battery modules includes a housing. Each of the plurality of battery modules also includes a plurality of electrochemical cells disposed adjacent to each other and received within the housing. Each of the plurality of battery modules further includes an inner cover disposed between the housing and the plurality of electrochemical cells. The inner cover includes a top surface facing the housing and a bottom surface facing the plurality of electrochemical cells. The inner cover also includes a plurality of fluid channels defined on the bottom surface and extending along a length of the inner cover. Each of the plurality of channels is configured to receive a fluid. The inner cover further includes a plurality of grooves defined on the top surface and extending along the length of the inner cover. Each of the plurality of grooves is configured to receive one or more electrical components.

Each of the plurality of channels and/or each of the plurality of grooves may guide the fluid within the housing, in turn, improving circulation of the fluid within the battery module. The inner cover may also tightly secure the plurality of electrochemical cells within the housing. Also, each of the plurality of grooves may accommodate the one or more electrical components, such as sensors and/or cables, thus, providing direct contact cooling/heating of the electrical components. The plurality of channels may further enable direct contact cooling/heating of the plurality of electrochemical cells. Accordingly, a combination of each of the plurality of channels and each of the plurality of grooves may provide improved thermal management efficiency, improved temperature distribution, reduced fluid volume, and reduced pumping power. The battery system mentioned above provides improved design flexibility for connection of the plurality of battery modules within the battery system. For example, a number of battery modules and the arrangement (e.g., series and/or parallel) of the battery modules may be varied as per application requirements.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic representation of a battery system, according to one embodiment of the present disclosure;

FIG. 2 is a perspective view of a battery module of the battery system;

FIG. 3 is an exploded perspective view of the battery module of FIG. 2;

FIG. 4 is a perspective view of an exemplary cell of the battery module of FIG. 2;

FIG. 5A is a top view of an inner cover of the battery module of FIG. 2;

FIG. 5B is a bottom view of the inner cover of FIG. 5A;

FIG. 5C is a sectional view of the battery module taken along line A-A′ of FIG. 2;

FIG. 6 is a sectional view of the battery module taken along line B-B′ of FIG. 2;

FIG. 7 is a perspective view of an endplate of the battery module of FIG. 2;

FIG. 8 is bottom view of an inner cover of the battery module of FIG. 2, according to another embodiment of the present disclosure;

FIG. 9 is a partial perspective view of a battery module, according to another embodiment of the present disclosure; and

FIG. 10 is a partial perspective view of a battery module, according to yet another embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

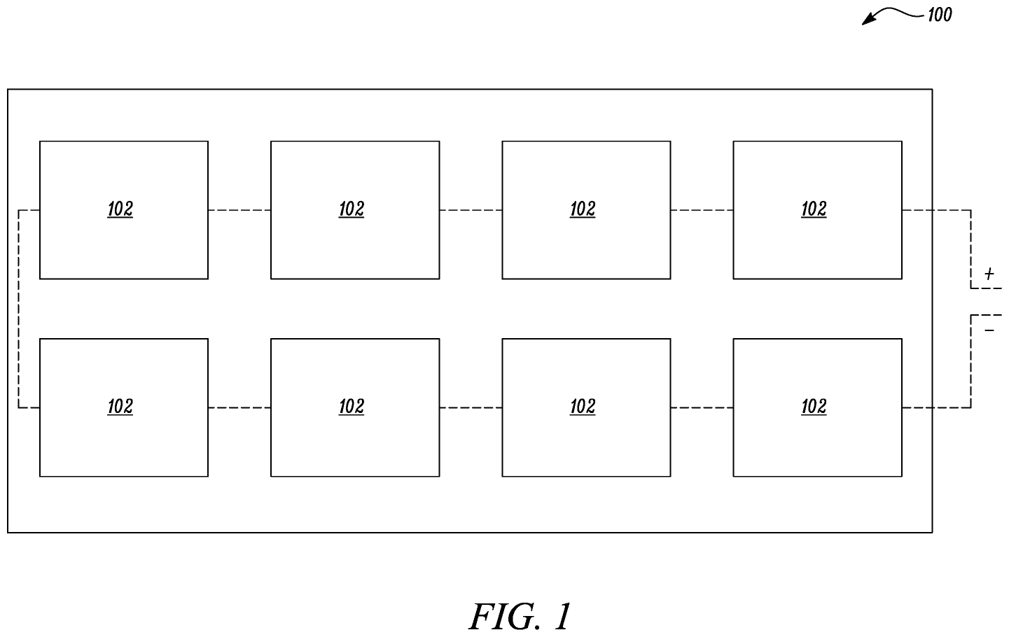

Referring to FIG. 1, a schematic representation of a battery system 100 is illustrated. The battery system 100 includes a plurality of battery modules 102. Each of the battery modules 102 is electrically connected to each other. Each of the battery modules 102 may be connected to each other using any electrical conductor, such as busbars, wires, cables, and the like. Also, in the illustrated embodiment, each of the battery modules 102 is electrically connected to each other in a combined series and parallel configuration. In other embodiments, each of the battery modules 102 may be electrically connected to each other in a series configuration. In yet other embodiments, each of the battery modules 102 may be electrically connected to each other in a parallel configuration, based on application requirements. A number and an arrangement of the battery modules 102 may be varied as per application requirements.

In the illustrated embodiment, the battery system 100 includes eight battery modules 102. In other embodiments, the battery system 100 may include single or multiple battery modules, based on a required electrical capacity of the battery system 100. The battery system 100 may be configured to store and supply electrical power to any electrical system, such as in a Battery Electric Vehicle (BEV), a Plug-in Hybrid Electric Vehicle (PHEV), an Uninterruptible Power Supply (UPS) system, a residential electrical system, an industrial electrical system, a stationary energy storage system, and the like. The battery system 100 may be employed in any industry including, but not limited to, transportation, automotive, aerospace, marine, construction, information technology, power, oil and gas, and defense.

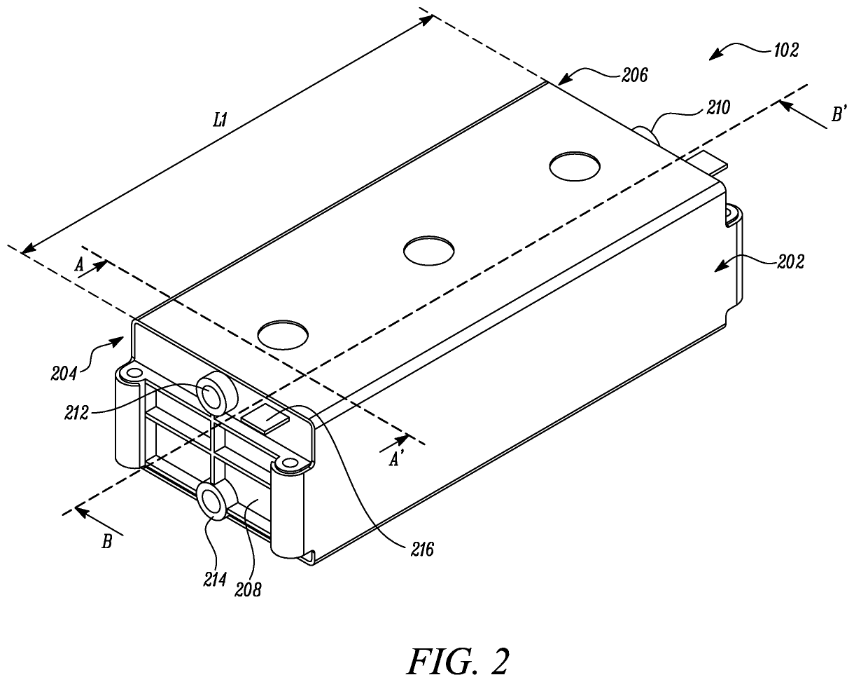

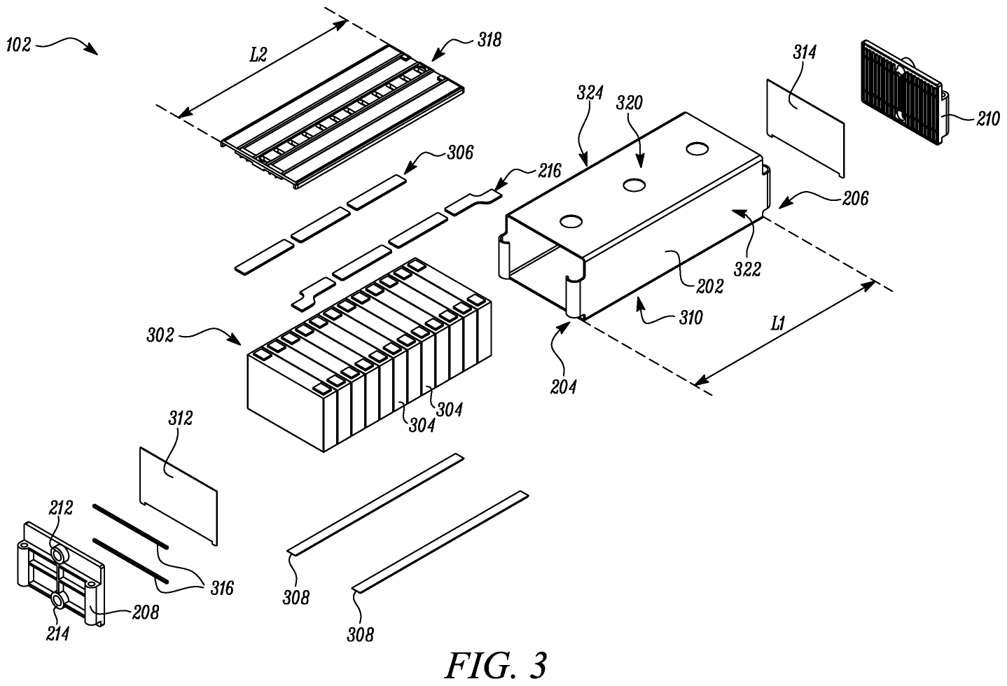

For explanatory purposes, a single battery module 102 will be explained in detail in the description provided below. However, it should be noted that the description provided below is applicable to all the battery modules 102 of the battery system 100. Referring to FIG. 2, a perspective view of the battery module 102 in an assembled position is illustrated. Referring to FIG. 3, an exploded perspective view of the battery module 102 is illustrated. The battery module 102 will now be explained with combined reference to FIGS. 2 and 3. The battery module 102 will be hereinafter interchangeably referred to as the “module 102”.

The module 102 includes a housing 202. The housing 202 is adapted to receive one or more components of the module 102. In the illustrated embodiment, the housing 202 has a substantially hollow, elongated and rectangular configuration. Accordingly, the housing 202 defines a first end 204 and a second end 206 disposed opposite the first end 204. The housing 202 also defines a length “L1” extending between each of the first end 204 and the second end 206. In other embodiments, the housing 202 may have any other configuration, such as a curved configuration, and the like, based on application requirements. The housing 202 may be made of any material, such as a polymer, a metal, an alloy, and the like. Also, the housing 202 may be manufactured using any manufacturing process, such as casting, forging, extrusion, molding, fabrication, additive manufacturing, and the like.

The module 102 includes a number of endplates, such as a first endplate 208 and a second endplate 210. The first endplate 208 is disposed on the first end 204 of the housing 202. The second endplate 210 is disposed on the second end 206 of the housing 202. Each of the first endplate 208 and the second endplate 210 is adapted to close the first end 204 and the second end 206 of the housing 202, respectively. Each of the first endplate 208 and the second endplate 210 may be coupled to the first end 204 and the second end 206 of the housing 202, respectively, using any coupling method, such as welding, bolting, and the like. Each of the first endplate 208 and the second endplate 210 may be made of any material, such as a metal, an alloy, and the like. Also, each of the first endplate 208 and the second endplate 210 may be manufactured using any manufacturing process, such as casting, forging, extrusion, molding, fabrication, additive manufacturing, and the like.

In the illustrated embodiment, the first endplate 208 also includes a fluid inlet 212 and a fluid outlet 214. The fluid outlet 214 is disposed spaced apart from the fluid inlet 212. The fluid inlet 212 is adapted to receive a flow of fluid into the housing 202. The fluid outlet 214 is adapted to allow the flow of fluid out of the housing 202. The fluid may be any thermal management liquid, such as a dielectric thermal management fluid. In some embodiments, the dielectric thermal management fluid may be any single-phase thermal management fluid. In other embodiments, the dielectric thermal management fluid may be any two-phase thermal management fluid. In yet other embodiments, the dielectric thermal management fluid may be any fluorochemical-based dielectric thermal management fluid. The dielectric thermal management fluid may be adapted to provide direct contact type or immersion type cooling/heating of the components of the module 102 disposed within the housing 202. In other embodiments, the fluid inlet 212 and/or the fluid outlet 214 may be, additionally or alternatively, provided on the second endplate 210, based on application requirements.

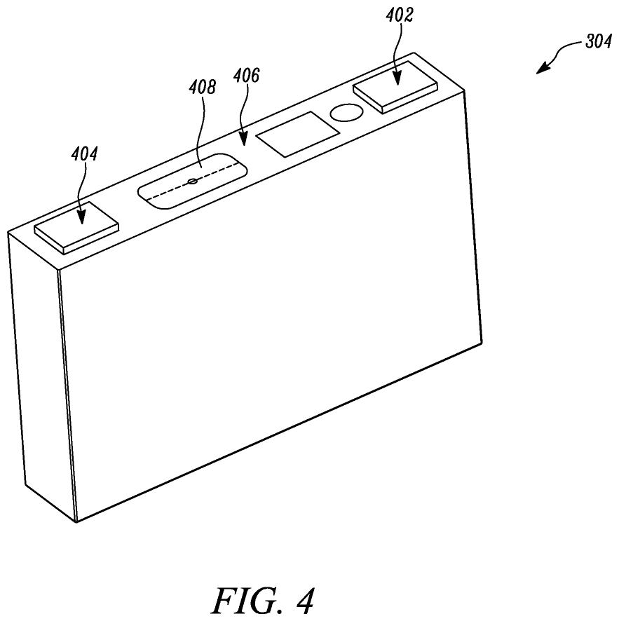

The module 102 also includes a cell stack 302 having a plurality of electrochemical cells 304. The electrochemical cell 304 will be hereinafter interchangeably referred to as the “cell 304”. Each of the cells 304 is disposed adjacent to each other and is received within the housing 202. In the illustrated embodiment, each of the cells 304 has a configuration similar to each other. Also, a number of cells 304 shown in the accompanying figure is merely exemplary and may vary based on application requirements. Referring to FIG. 4, a perspective view of the exemplary cell 304 is illustrated. In the illustrated embodiment, the cell 304 is a prismatic type electrochemical cell. In other embodiments, the cell 304 may be a pouch type electrochemical cell. Accordingly, the cell 304 has a substantially elongated and rectangular configuration. The cell 304 may be any electrochemical cell, such as a Lithium-Ion type electrochemical cell, a Lithium-Polymer type electrochemical cell, and the like.

The cell 304 also includes one or more electric terminals, such as a positive terminal 402 and a negative terminal 404, disposed on a top portion 406 of the cell 304. In other embodiments, the electric terminals may be disposed on any other portion of the cell 304, based on application requirements. The cell 304 further includes a rupture disc 408 disposed on the top portion 406 of the cell 304. The rupture disc 408 is adapted to open based on a pressure within the cell 304 exceeding a predetermined threshold. As such, the rupture disc 408 is adapted to allow venting of gas generated within the cell 304 based on the pressure within the cell 304 exceeding the predetermined threshold, such as during a battery thermal runaway event. The cell 304 may additionally include various components (not shown), such as one or more electrodes, sensors, circuitry components, and the like, based on application requirements.

Referring to FIGS. 2 and 3, the module 102 includes a first busbar set 216 and a second busbar set 306. Each of the first busbar set 216 and the second busbar set 306 is adapted to provide electrical connection between each of the cells 304. Additionally, the first busbar set 216 is adapted to provide electrical connection between each adjacent modules 102 of the battery system 100. Each of the first busbar set 216 and the second busbar set 306 may be made of any electrically conductive material, such as a metal, an alloy, and the like. Also, each of the first busbar set 216 and the second busbar set 306 may be manufactured using any manufacturing process, such as casting, forging, extrusion, molding, fabrication, additive manufacturing, and the like.

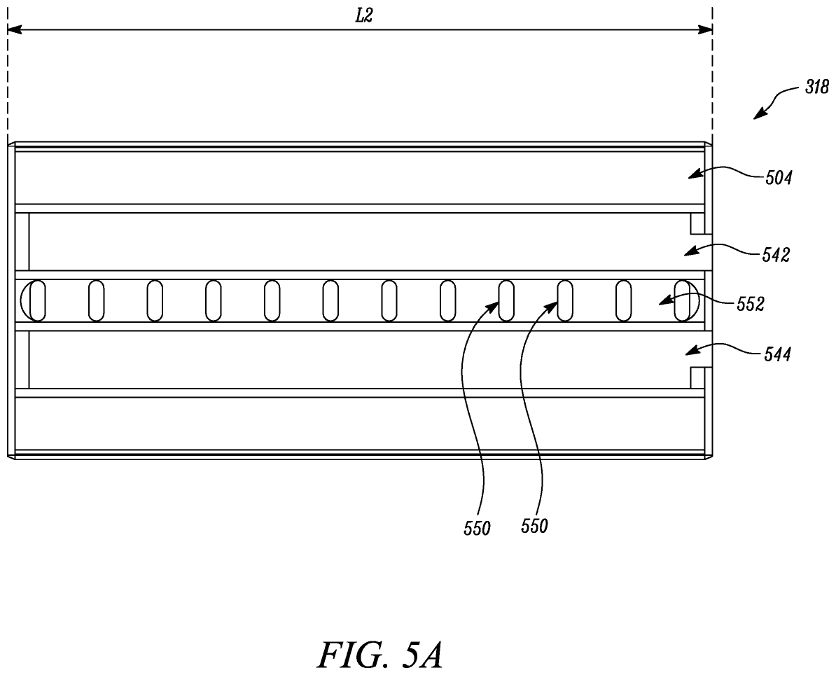

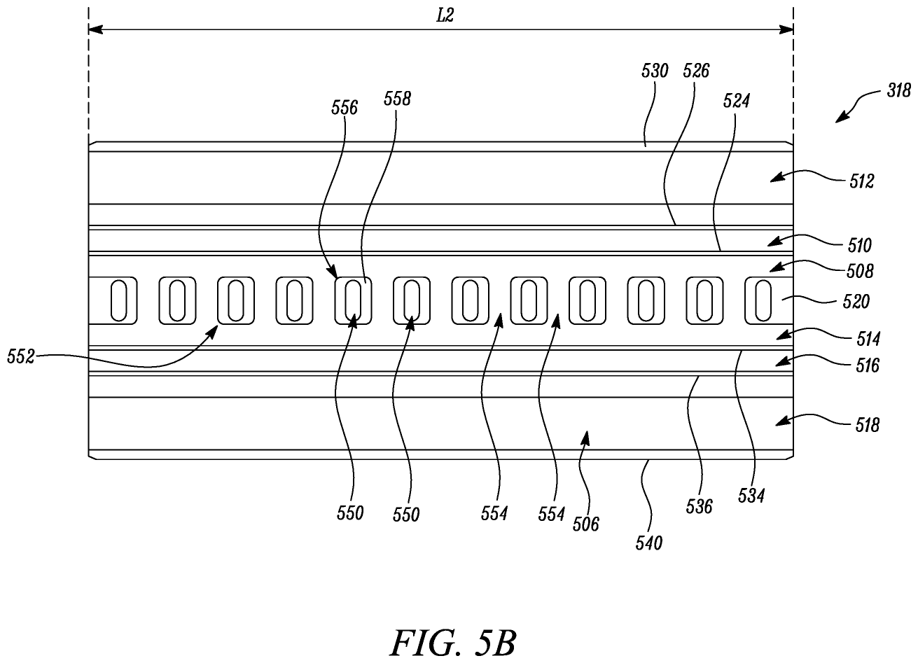

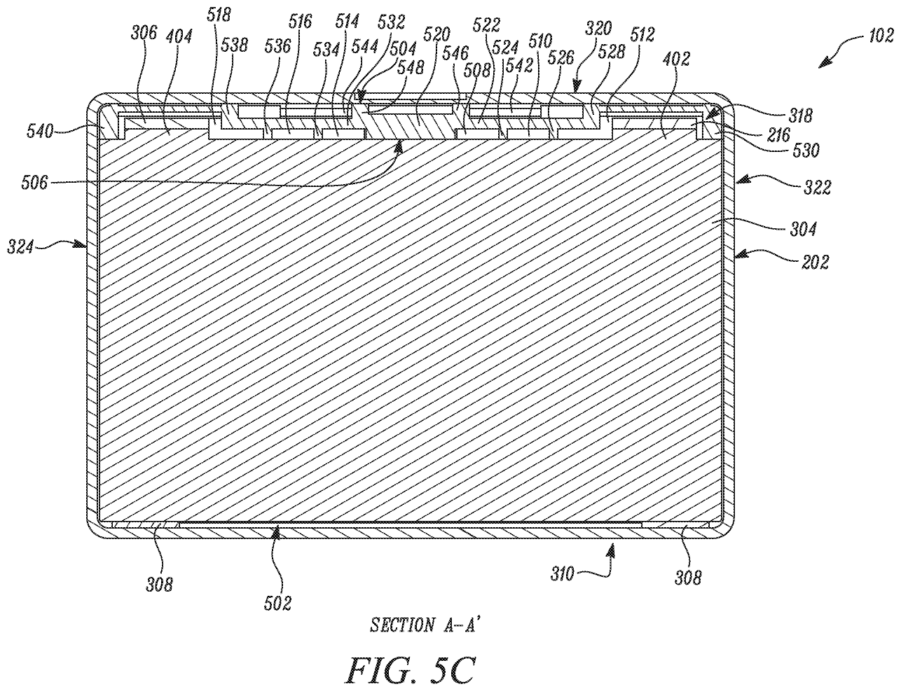

The module 102 also includes a pair of support mounts 308. Each of the support mounts 308 is disposed in the housing 202 on a bottom portion 310 of the housing 202. Each of the support mounts 308 is adapted to receive and support each of the cells 304 within the housing 202. Accordingly, a gap 502 (shown in FIG. 5C) is provided between each of the cells 304 and the bottom portion 310 of the housing 202. In the illustrated embodiment, the module 102 includes two support mounts 308. In other embodiments, the module 102 may include single or multiple support mounts, based on application requirements. Each of the support mounts 308 may be made of any material, such as a polymer, a metal, an alloy, and the like. Also, each of the support mounts 308 may be manufactured using any manufacturing process, such as casting, forging, extrusion, molding, fabrication, additive manufacturing, and the like.

The module 102 also includes a number of pressure plates, such as a first pressure plate 312 and a second pressure plate 314. The first pressure plate 312 is adapted to be disposed at the first end 204 of the housing 202 between the first endplate 208 and the cell stack 302. The second pressure plate 314 is adapted to be disposed at the second end 206 of the housing 202 between the second endplate 210 and the cell stack 302. Each of the first pressure plate 312 and the second pressure plate 314 may be made of any material, such as a polymer, a metal, an alloy, and the like. Also, each of the first pressure plate 312 and the second pressure plate 314 may be manufactured using any manufacturing process, such as casting, forging, extrusion, molding, fabrication, additive manufacturing, and the like.

The module 102 also includes a pair of flow blockers 316. Each of the flow blockers 316 is disposed at the first end 204 of the housing 202 between the first endplate 208 and the first pressure plate 312. Also, each of the flow blockers 316 is disposed spaced apart from each other. Each of the flow blockers 316 is adapted to limit the flow of fluid from the fluid inlet 212 directly toward the fluid outlet 214 and vice versa. Each of the flow blockers 316 may be made of any material, such as a polymer, a metal, an alloy, and the like. Also, each of the flow blockers 316 may be manufactured using any manufacturing process, such as casting, forging, extrusion, molding, fabrication, additive manufacturing, and the like. The module 102 may also include additional electrical components (not shown), such as a current sensor, a flow sensor, a temperature sensor, a conductivity sensor, a Printed Circuit Board (PCB), a controller, wires, cables, components of a Battery Management System (BMS), and the like, based on application requirements.

The module 102 further includes an inner cover 318. The inner cover 318 is disposed between the housing 202 and each of the cells 304. More specifically, in the illustrated embodiment, the inner cover 318 is disposed adjacent to a top portion 320 of the housing 202 and within the housing 202. In other embodiments, the inner cover 318 may be alternatively disposed adjacent to the bottom portion 310 of the housing 202 and within the housing 202. In the illustrated embodiment, the module 102 includes a single inner cover 318. In other embodiments, the module 102 may include multiple inner covers. In such a situation, each of the multiple inner covers may be disposed at various locations within the housing 202, such as adjacent to the top portion 320, the bottom portion 310, a front portion 322, a rear portion 324, the first end 204, and/or the second end 206, and between the housing 202 and each of the cells 304. The inner cover 318 may be made of any material, such as a metal, an alloy, a polymer, and the like. The inner cover 318 may be manufactured using any manufacturing process, such as casting, forging, extrusion, molding, fabrication, additive manufacturing, and the like.

Referring to FIG. 5A, a top view of the inner cover 318 is illustrated. Referring to FIG. 5B, a bottom view of the inner cover 318 is illustrated. Referring to FIG. 5C, a sectional view of the inner cover 318 is illustrated. The inner cover 318 will now be explained with combined reference to FIGS. 5A, 5B, and 5C. The inner cover 318 has a substantially flat and elongate configuration. In other embodiments, the inner cover 318 may have any other configuration, such as a curved configuration, and the like, based on application requirements. Accordingly, the inner cover 318 includes a top surface 504 and a bottom surface 506 disposed opposite to the top surface 504. The inner cover 318 is adapted to be disposed within the housing 202 such that the top surface 504 may face the housing 202 and the bottom surface 506 may face each of the cells 304.

The inner cover 318 also includes a plurality of fluid channels defined on the bottom surface 506. In the illustrated embodiment, the fluid channels include six channels, such as a first channel 508, a second channel 510, a third channel 512, a fourth channel 514, a fifth channel 516, and a sixth channel 518. In other embodiments, the inner cover 318 may include any number of fluid channels, based on application requirements. More specifically, the first channel 508 is defined between a central wall 520, a first transverse wall 522, and a first wall 524. The second channel 510 is defined between the first wall 524, the first transverse wall 522, and a second wall 526. The third channel 512 is defined between the second wall 526, the first transverse wall 522, a first auxiliary wall 528, the bottom surface 506, and a third wall 530. The fourth channel 514 is defined between the central wall 520, a second transverse wall 532, and a fourth wall 534. The fifth channel 516 is defined between the fourth wall 534, the second transverse wall 532, and a fifth wall 536. The sixth channel 518 is defined between the fifth wall 536, the second transverse wall 532, a second auxiliary wall 538, the bottom surface 506, and a sixth wall 540.

In the illustrated embodiment, each of the first wall 524, the second wall 526, the third wall 530, the fourth wall 534, the fifth wall 536, the sixth wall 540, the first transverse wall 522, the second transverse wall 532, the first auxiliary wall 528, the second auxiliary wall 538, and the top surface 504 is disposed adjacent to one another and extends along a length “L2” of the inner cover 318. Accordingly, each of the first channel 508, the second channel 510, the third channel 512, the fourth channel 514, the fifth channel 516, and the sixth channel 518 extends along the length “L2” of the inner cover 318. Each of the first channel 508, the second channel 510, the third channel 512, the fourth channel 514, the fifth channel 516, and the sixth channel 518 is adapted to receive the fluid from the fluid inlet 212 and further guide the flow of fluid from the first end 204 toward the second end 206 of the housing 202. Also, in the illustrated embodiment, each of the third channel 512 and the sixth channel 518 includes the first busbar set 216 and the second busbar set 306, respectively. In other embodiments, each of the first channel 508, the second channel 510, the third channel 512, the fourth channel 514, the fifth channel 516, and the sixth channel 518 may include any other electrical components, such as components to monitor one or more parameters of the thermal management fluid including, but not limited to, humidity sensors, flow sensors, temperature sensors, resistance/electrical conductivity sensors, wires, cables, and the like.

The inner cover 318 also includes a plurality of grooves defined on the top surface 504. In the illustrated embodiment, the top surface 504 of the inner cover 318 includes two grooves, such as a first groove 542 and a second groove 544. In other embodiments, the inner cover 318 may include any number of grooves, based on application requirements. The first groove 542 is defined between the first auxiliary wall 528, the first transverse wall 522, a third auxiliary wall 546, and the top surface 504. The second groove 544 is defined between the second auxiliary wall 538, the second transverse wall 532, a fourth auxiliary wall 548, and the top surface 504. Each of the first auxiliary wall 528, the second auxiliary wall 538, the third auxiliary wall 546, the fourth auxiliary wall 548, the first transverse wall 522, the second transverse wall 532, and the top surface 504 extends along the length “L2” of the inner cover 318. Accordingly, each of the first groove 542 and the second groove 544 is disposed adjacent to one another and extends along the length “L2” of the inner cover 318. Each of the first groove 542 and the second groove 544 is adapted to receive the fluid from the fluid inlet 212 and further guide the flow of fluid from the first end 204 toward the second end 206 of the housing 202. Also, each of the first groove 542 and the second groove 544 is adapted to receive one or more electrical components. In some embodiments, the one or more electrical components are configured to monitor one or more parameters of the thermal management fluid, such as humidity, flow rate, electrical conductivity, and the like. The one or more electrical components may include components to monitor the thermal management fluid including, but not limited to, humidity sensors, flow sensors, temperature sensors, resistance/electrical conductivity sensors, and the like. The one or more electrical components may further include cables, wires, circuitry components, and the like. Additionally, each of the first groove 542 and the second groove 544 is further adapted to receive the fluid from the fluid inlet 212 and guide the flow of fluid from the first end 204 toward the second end 206 of the housing 202.

The inner cover 318 also defines a plurality of openings 550. Each of the openings 550 are through openings that extend between the top surface 504 and the bottom surface 506. Each of the openings 550 is disposed along the length “L2” of the inner cover 318 in a middle region 552 of the inner cover 318 and spaced apart from each other. It should be noted that a number of openings 550 shown in the accompanying figure is merely exemplary and corresponds to the number of cells 304. In the illustrated embodiment, each of the openings 550 has a substantially oblong configuration. In other embodiments, one or more of the openings 550 may have any other configuration, such as circular, elliptical, oval, polygonal, and the like. Each of the openings 550 is disposed on the inner cover 318 and aligned with respect to the rupture disc 408 of a corresponding cell 304. Specifically, positions of the plurality of openings 550 in a length direction (i.e., along the length “L2”) corresponds to positions of the plurality of electrochemical cells 304, so that each of the plurality of openings 550 is arranged above a corresponding electrochemical cell 304. Accordingly, each of the openings 550 is adapted to allow venting of gas from the corresponding cell 304 upon opening of the respective rupture disc 408.

The inner cover 318 also includes a number of cross-channels 554. Each of the cross-channels 554 is disposed between each of the openings 550. Also, each of the cross-channels 554 extend transversely relative to the length “L2” of the inner cover 318. Each of the cross-channels 554 is provided in fluid communication with each of the first channel 508 and the fourth channel 514. Accordingly, each of the cross-channels 554 is adapted to allow the flow of fluid between the first channel 508 and the fourth channel 514 through each of the cross-channels 554.

The inner cover 318 further includes one or more blocking features 556. The blocking feature 556 is adapted to prevent the flow of fluid from the fluid channels to each of the openings 550. In the illustrated embodiment, the blocking feature 556 includes a plurality of raised portions 558. Each of the raised portions 558 is disposed on the bottom surface 506 of the inner cover 318. The raised portions 558 extend from the bottom surface 506 of the inner cover 318. Also, each of the raised portions 558 is disposed in association with the corresponding opening 550. More specifically, each of the raised portions 558 is disposed around each of the corresponding opening 550. Accordingly, the number of raised portions 558 correspond to the number of openings 550 provided on the inner cover 318. Each of the raised portions 558 is adapted to contact each of the corresponding cell 304 in order to create a seal around the rupture disc 408 of the corresponding cell 304. Accordingly, each of the raised portions 558 prevents the flow of fluid from the fluid channels, such as the first channel 508, the second channel 510, the third channel 512, the fourth channel 514, the fifth channel 516, the sixth channel 518, and/or each of the cross-channels 554 into each of the corresponding openings 550 and further on the corresponding rupture disc 408.

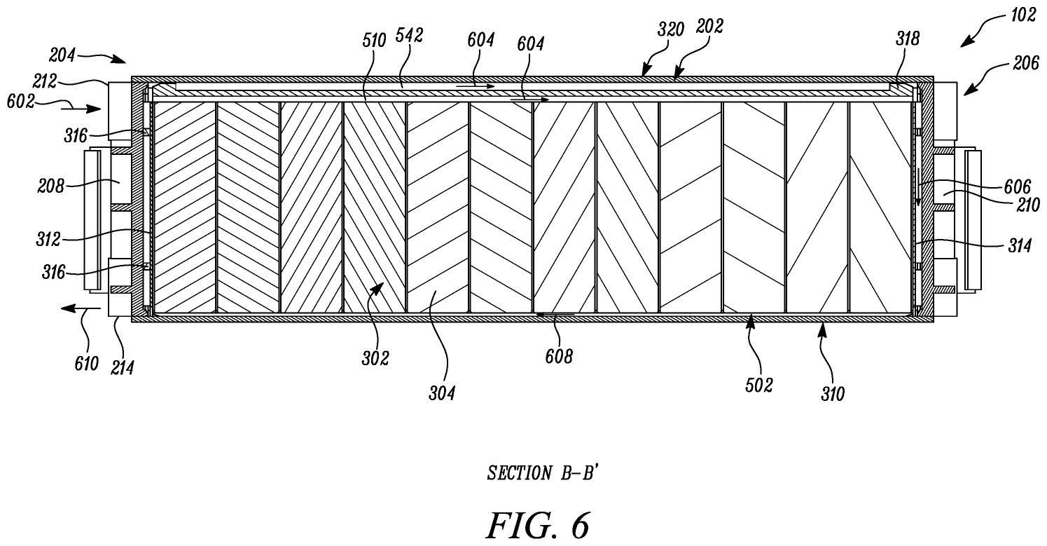

A raised portion 558 of a blocking feature 556 may comprise a layer of adhesive for adhesively attaching the raised portion 558 to the corresponding electrochemical cell 304. This adhesive attachment may create a particularly effective seal around the rupture disc 408 of the cell 304 and thereby further reduce the risk of fluid flowing from the fluid channels, such as the first channel 508, the second channel 510, the third channel 512, the fourth channel 514, the fifth channel 516, the sixth channel 518, and/or each of the cross-channels 554 into each of the corresponding openings 550 and further on the corresponding rupture disc 408. The layer of adhesive may be arranged at a portion of the raised portion 558 which is distal from the bottom surface 506. Hence in certain embodiments at least one of the plurality of raised portions 558 is adhesively attached to one of the plurality of electrochemical cells 304. Referring to FIG. 6, another sectional view of the module 102 is illustrated. During operation, in the assembled position of the module 102, the fluid is received into the housing 202 through the fluid inlet 212, as shown by an arrow 602. More specifically, a fluid pump (not shown) may be used to generate the flow of fluid from a fluid reservoir (not shown) to the fluid inlet 212. The flow of fluid may be controlled by a controller (not shown) based on input signals received from various sensors (not shown), such as a flow rate sensor, a temperature sensor, and the like. The fluid then flows from the first end 204 toward the second end 206 of the housing 202 adjacent to the top portion 320 of the housing 202 between the housing 202 and each of the cells 304, as shown by arrows 604. More specifically, the fluid flows through each of the first channel 508, the second channel 510, the third channel 512, the fourth channel 514, the fifth channel 516, the sixth channel 518, the first groove 542, and the second groove 544 provided in the inner cover 318 from the first end 204 toward the second end 206 of the housing 202. Additionally, the flow of fluid is limited or restricted from the fluid inlet 212 directly into the fluid outlet 214 at the first end 204 of the housing 202 by each of the flow blockers 316.

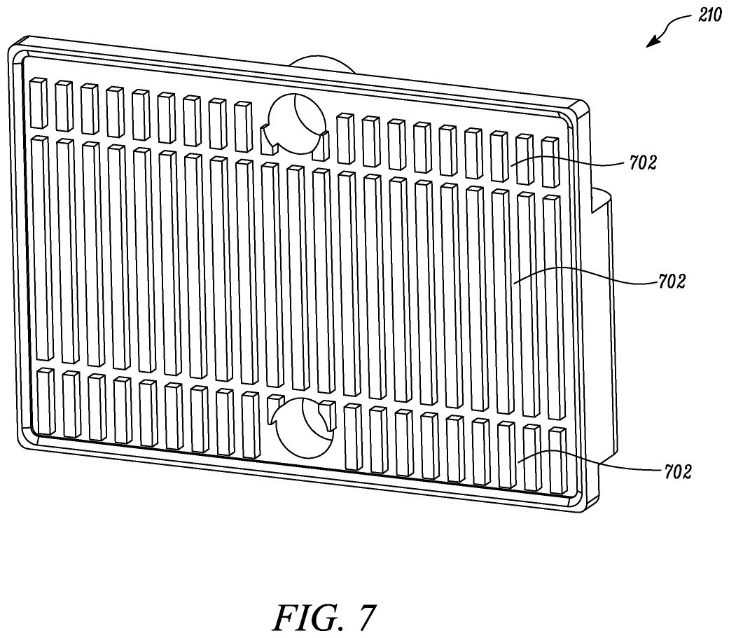

At the second end 206 of the housing 202, the fluid then flows from the top portion 320 to the bottom portion 310 of the housing 202 between the cell stack 302 and the second endplate 210, as shown by an arrow 606. Referring to FIG. 7, a perspective view of the second endplate 210 is illustrated. The second endplate 210 includes a number of auxiliary grooves 702. Each of the auxiliary grooves 702 is adapted to direct the flow of fluid from the top portion 320 to the bottom portion 310 at the second end 206 of the housing 202. Referring to FIG. 6, the fluid then flows from the second end 206 toward the first end 204 of the housing 202 adjacent to the bottom portion 310 of the housing 202 between the housing 202 and each of the cells 304, as shown by the arrows 608. More specifically, the fluid flows through the gap 502 provided between each of the cells 304 and the bottom portion 310 of the housing 202. The fluid further flows out of the housing 202 through the fluid outlet 214, as shown by an arrow 610. Additionally, the flow of fluid is limited from the fluid outlet 214 directly into the fluid inlet 212 at the first end 204 of the housing 202 using each of the flow blockers 316. In the illustrated embodiment, the flow of fluid is a substantially U-shaped flow such that the fluid floods the housing 202 and submerges each of the cells 304. It should be noted that the flow of fluid described herein is merely exemplary and may vary based on application requirements. For example, in other embodiments, the flow of fluid may have any configuration, such as a cross type flow, a linear type flow, and the like.

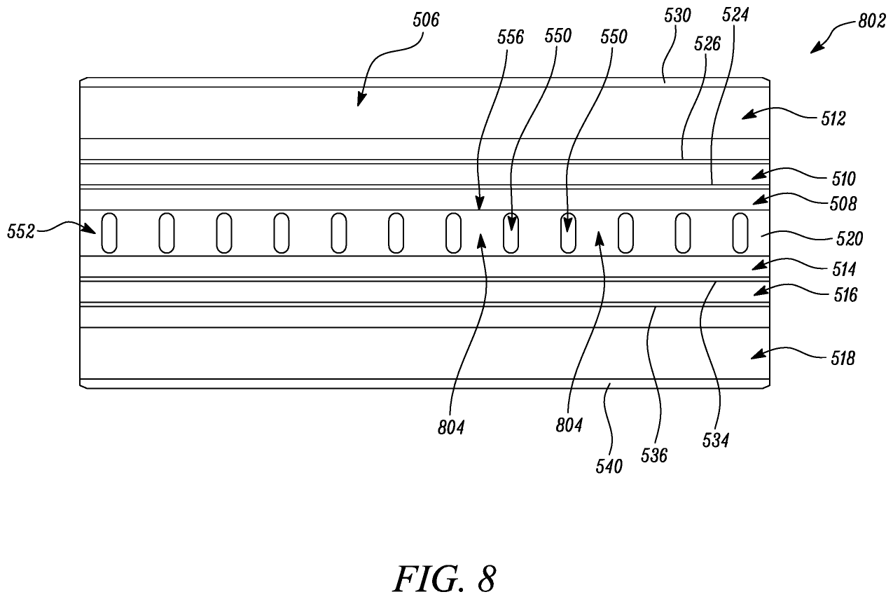

Referring to FIG. 8, a bottom view of an inner cover 802 is illustrated. The inner cover 802 has a configuration substantially similar to the configuration of the inner cover 318, as described above with reference to FIGS. 5A, 5B, and 5C. More specifically, the inner cover 802 includes each of the first channel 508, the second channel 510, the third channel 512, the fourth channel 514, the fifth channel 516, the sixth channel 518, the first groove 542, the second groove 544, and each of the openings 550. However, instead of the raised portions 558, the inner cover 802 includes a plurality of cross-barriers 804. Each of the cross-barriers 804 is disposed between each of the openings 550. Also, each of the cross-barriers 804 extend transversely relative to the length “L2” of the inner cover 802. Each of the cross-barriers 804 extend from the bottom surface 506 of the inner cover 802. Accordingly, each of the cross-barriers 804 is adapted to limit the flow of fluid between each of the first channel 508 and the fourth channel 514 and into each of the openings 550.

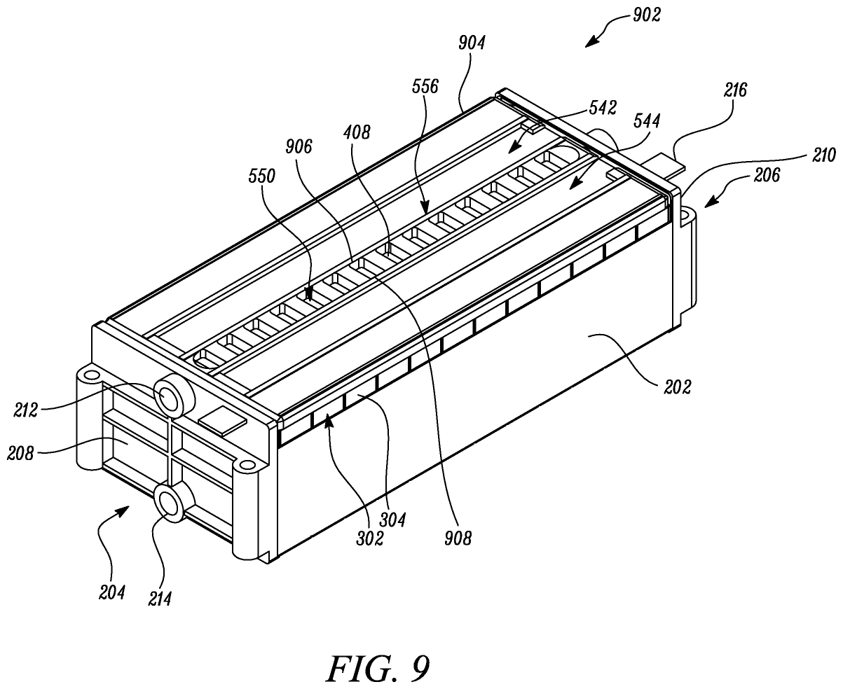

Referring to FIG. 9, a partial perspective view of a battery module 902 is illustrated. The module 902 has a configuration substantially similar to the configuration of the module 102. It should be noted that, in the accompanying figure, some portions of the housing 202 have been omitted for purpose of clarity and explanation. The housing 202 includes an inner cover 904 having a configuration substantially similar to the configuration of the inner cover 318, as described above with reference to FIGS. 5A, 5B, and 5C. However, the inner cover 904 includes a pair of barrier members, such as a first barrier member 906 and a second barrier member 908. Each of the first barrier member 906 and the second barrier member 908 extends along the length “L2” of the inner cover 904. Each of the first barrier member 906 and the second barrier member 908 is disposed on opposing sides of each of the openings 550. Also, each of the first barrier member 906 and the second barrier member 908 is disposed on a corresponding side of the middle region 552 of the inner cover 904. Each of the first barrier member 906 and the second barrier member 908 is adapted to contact each of the cells 304 and create a seal between the inner cover 904 and each of the cells 304 in order to limit the flow of fluid from each of the first channel 508, the second channel 510, the third channel 512, the fourth channel 514, the fifth channel 516, and/or the sixth channel 518 into each of the openings 550.

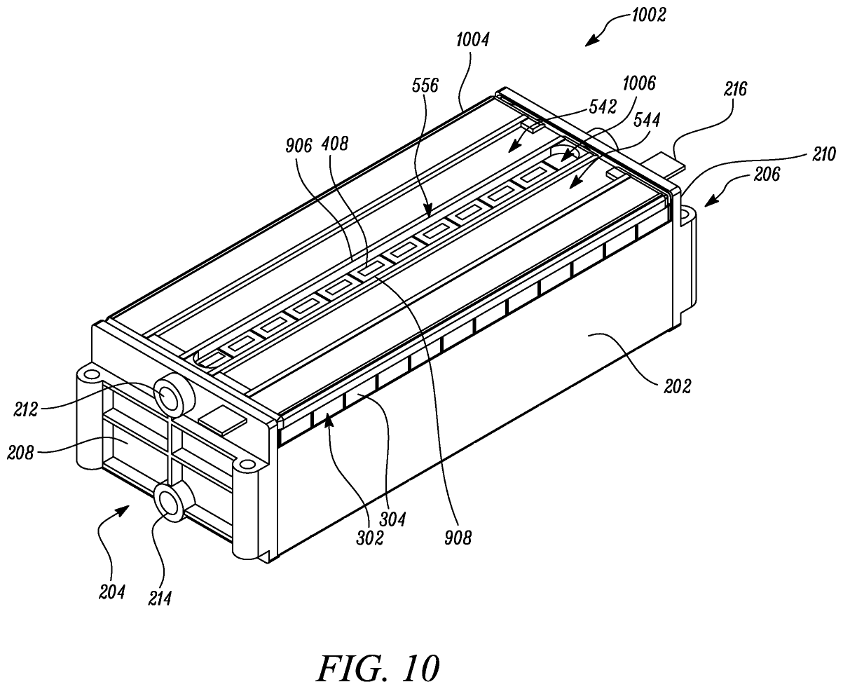

Referring to FIG. 10, a partial perspective view of a battery module 1002 is illustrated. The module 1002 has a configuration substantially similar to the configuration of the module 102. It should be noted that, in the accompanying figure, some portions of the housing 202 have been omitted for purpose of clarity and explanation. The housing 202 includes an inner cover 1004 having a configuration substantially similar to the configuration of the inner cover 904 as described with reference to FIG. 9. However, in the illustrated embodiment, the inner cover 1004 includes a single opening 1006 extending along the length “L2” of the inner cover 1004. The opening 1006 is provided in the middle region 552 of the inner cover 1004 and is aligned with the rupture discs 408 of each of the cells 304. Additionally, the inner cover 1004 includes the first barrier member 906 and the second barrier member 908. Each of the first barrier member 906 and the second barrier member 908 extends along the length “L2” of the inner cover 1004. Each of the first barrier member 906 and the second barrier member 908 is disposed on opposing sides of the opening 1006. Each of the first barrier member 906 and the second barrier member 908 is adapted to contact each of the cells 304 and create a seal between the inner cover 1004 and each of the cells 304 in order to limit the flow of fluid from each of the first channel 508, the second channel 510, the third channel 512, the fourth channel 514, the fifth channel 516, and/or the sixth channel 518 into the opening 1006.

The inner cover 318, 802, 904, 1004 provides a simple and effective method to provide the guide for the flow of fluid within the housing 202 through each of the number of channels and each of the number of grooves. As such, circulation of the fluid within the housing 202 is improved, in turn, improving thermal management efficiency. Also, each of the first channel 508, the second channel 510, the third channel 512, the fourth channel 514, the fifth channel 516, the sixth channel 518, the first groove 542, and/or the second groove 544 may accommodate one or more electrical circuitry components associated with the module 102, 902, 1002, such as sensors, cables, wires, busbars, and the like, in order to provide direct contact cooling/heating of the electrical components along with direct contact cooling/heating of each of the cells 304. Further, a dimensional configuration, such as a height, a width, a length, and the like, of each of the first channel 508, the second channel 510, the third channel 512, the fourth channel 514, the fifth channel 516, the sixth channel 518, the first groove 542, and/or the second groove 544 may be modified, based on application requirements, in order to meet required flow and thermal management performance, in turn, improving product flexibility.

Additionally, the inner cover 318 includes each of the openings 550. Each of the openings 550 include corresponding raised portion 558. The inner cover 802 includes each of the openings 550. The openings 550 include corresponding cross-barriers 804 disposed therebetween. The inner cover 904 includes each of the openings 550. The inner cover 904 also includes the first barrier member 906 and the second barrier member 908 disposed adjacent to each of the openings 550. The inner cover 1004 includes the opening 1006. The inner cover 1006 also includes the first barrier member 906 and the second barrier member 908 disposed adjacent to the opening 1006. Each of the openings 550, 1006 allows venting of the gas from the corresponding cell 304 upon opening of the respective rupture disc 408. Additionally, each of the raised portions 558, or each of the first barrier member 906 and the second barrier member 908 prevents mixing of the fluid with the vent gas. As such, contamination of the fluid by the vent gas and entry of the fluid into the ruptured cell 304 may be prevented. The inner cover 318, 802, 904, 1004 provides a simplified configuration and can be retrofitted in any battery module with little or no modification to the existing configuration.

The fluid used with the battery system 100 and the battery modules 102 may be a thermal management fluid, a heating fluid, or a cooling fluid. Suitable thermal management fluids may include or consist essentially of halogenated compounds, oils (e.g., mineral oils, synthetic oils, or silicone oils), or combinations thereof. In some embodiments, the halogenated compounds may include fluorinated compounds, chlorinated compounds, brominated compounds, or combinations thereof. In some embodiments, the halogenated compounds may include or consist essentially of fluorinated compounds. In some embodiments, the thermal management fluids may have an electrical conductivity (at 25 degrees Celsius) of less than about 1e-5 S/cm, less than about 1e-6 S/cm, less than 1e-7 S/cm, or less than about 1e-10 S/cm. In some embodiments, the thermal management fluids may have a dielectric constant that is less than about 25, less than about 15, or less than about 10, as measured in accordance with ASTM D150 at room temperature. In some embodiments, the thermal management fluids may have any one of, any combination of, or all of the following additional properties: sufficiently low melting point (e.g., <−40 degrees C.) and high boiling point (e.g., >80 degrees C. for single phase heat transfer), high thermal conductivity (e.g., >0.05 W/m-K), high specific heat capacity (e.g., >800 J/kg-K), low viscosity (e.g., <2 cSt at room temperature), and non-flammability (e.g., no closed cup flashpoint) or low flammability (e.g., flash point >100 F). In some embodiments, fluorinated compounds having such properties may include or consist of any one or combination of fluoroethers, fluorocarbons, fluoroketones, fluorosulfones, and fluoroolefins. In some embodiments fluorinated compounds having such properties may include or consist of partially fluorinated compounds, perfluorinated compounds, or a combination thereof.

As used herein, “fluoro-” (for example, in reference to a group or moiety, such as in the case of “fluoroalkylene” or “fluoroalkyl” or “fluorocarbon”) or “fluorinated” means (i) partially fluorinated such that there is at least one carbon-bonded hydrogen atom, or (ii) perfluorinated.

As used herein, “perfluoro-” (for example, in reference to a group or moiety, such as in the case of “perfluoroalkylene” or “perfluoroalkyl” or “perfluorocarbon”) or “perfluorinated” means completely fluorinated such that, except as may be otherwise indicated, there are no carbon-bonded hydrogen atoms replaceable with fluorine.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A battery module comprising:
a housing;
a plurality of electrochemical cells disposed adjacent to each other and received within the housing; and
an inner cover disposed between the housing and the plurality of electrochemical cells, the inner cover comprising:
a top surface facing the housing and a bottom surface facing the plurality of electrochemical cells;
a plurality of fluid channels defined on the bottom surface and extending along a length of the inner cover, wherein each of the plurality of channels is configured to receive a fluid; and
a plurality of grooves defined on the top surface and extending along the length of the inner cover, wherein each of the plurality of grooves is configured to receive one or more electrical components.

2. The battery module of claim 1, wherein the inner cover further defines a plurality of openings spaced apart from each other along the length of the inner cover.

3. The battery module of claim 2, wherein each of the plurality of electrochemical cells further comprises a rupture disc configured to open when a pressure within the respective electrochemical cell exceeds a predetermined threshold, and wherein each of the plurality of openings is aligned with the rupture disc of a corresponding electrochemical cell to allow venting of gas from the corresponding electrochemical cell upon opening of the rupture disc.

4. The battery module of claim 2, wherein the inner cover further comprises one or more blocking features to prevent flow of fluid from the plurality of fluid channels to the plurality of openings.

5. The battery module of claim 4, wherein the plurality of openings is disposed in a middle region of the inner cover, and wherein the one or more blocking features comprise a pair of barrier members extending along the length of the inner cover, each of the pair of barrier members disposed on a corresponding side of the middle region.

6. The battery module of claim 4, wherein the one or more blocking feature comprise a plurality of cross-barriers extending transversely relative to the length of the inner cover, each of the plurality of cross-barriers disposed between two adjacent openings of the plurality of openings.

7. The battery module of claim 4, wherein the one or more blocking features comprises a plurality of raised portions disposed on the bottom surface, each of the plurality of raised portions disposed around a corresponding opening of the plurality of openings.

8. The battery module of claim 7, wherein at least one of the plurality of raised portions is adhesively attached to one of the plurality of electrochemical cells.

9. The battery module of claim 1, wherein each of the plurality of grooves is further configured to receive the fluid.

10. The battery module of claim 1, wherein the fluid is a thermal management liquid.

11. The battery module of claim 10, wherein the one or more electrical components are configured to monitor one or more parameters of the thermal management liquid.

12. A battery module comprising:
a housing;
a plurality of electrochemical cells disposed adjacent to each other and received within the housing; and
an inner cover disposed between the housing and the plurality of electrochemical cells, the inner cover comprising:
a top surface facing the housing and a bottom surface facing the plurality of electrochemical cells;
a plurality of fluid channels defined on the bottom surface and extending along a length of the inner cover, wherein each of the plurality of channels is configured to receive a fluid;
a plurality of openings spaced apart from each other along the length of the inner cover; and
one or more blocking features to prevent flow of fluid from the plurality of fluid channels to the plurality of openings.

13. The battery module of claim 12, wherein each of the plurality of electrochemical cells further comprises a rupture disc configured to open when a pressure within the respective electrochemical cell exceeds a predetermined threshold, and wherein each of the plurality of openings is aligned with the rupture disc of a corresponding electrochemical cell to allow venting of gas from the corresponding electrochemical cell upon opening of the rupture disc.

14. The battery module of claim 12, wherein the plurality of openings is disposed in a middle region of the inner cover, and wherein the one or more blocking features comprise a pair of barrier members extending along the length of the inner cover, each of the pair of barrier members disposed on a corresponding side of the middle region.

15. The battery module of claim 12, wherein the one or more blocking feature comprise a plurality of cross-barriers extending transversely relative to the length of the inner cover, each of the plurality of cross-barriers disposed between two adjacent openings of the plurality of openings.

16. The battery module of claim 12, wherein the one or more blocking features comprises a plurality of raised portions disposed on the bottom surface, each of the plurality of raised portions disposed around a corresponding opening of the plurality of openings.

17. The battery module of claim 16, wherein at least one of the plurality of raised portions is adhesively attached to one of the plurality of electrochemical cells.

18. The battery module of claim 12, wherein the inner cover further comprises a plurality of grooves defined on the top surface and extending along the length of the inner cover, wherein each of the plurality of grooves is configured to receive one or more electrical components.

19. The battery module of claim 18, wherein each of the plurality of grooves is further configured to receive the fluid.

20. The battery module of claim 12, wherein the fluid is a thermal management liquid.
